(19) United States
(12) Patent Application Publication
(10) Pub. No.: US 2024/0221999 A1
(43) Pub. Date: Jul. 4, 2024

(54) INDUCTOR STRUCTURE AND MANUFACTURING METHOD THEREOF

(71) Applicant: PHOENIX PIONEER TECHNOLOGY CO., LTD., Hsinchu County (TW)

(72) Inventors: Che-Wei HSU, Hsinchu County (TW); Pao-Hung CHOU, Hsinchu County (TW)

(73) Assignee: PHOENIX PIONEER TECHNOLOGY CO., LTD., Hsinchu County (TW)

(21) Appl. No.: 18/481,059

(22) Filed: Oct. 4, 2023

(30) Foreign Application Priority Data
Dec. 30, 2022 (TW) 111150978

(51) Int. Cl. H01F 27/32; H01F 41/04; H01F 41/12

(52) U.S. Cl. CPC H01F 27/323; H01F 41/041; H01F 41/122

(57) ABSTRACT

An inductor structure is provided, in which a coil-shaped inductor body and a magnetically permeable alloy layer located in the coil are embedded in an insulator, so as to improve the electrical characteristics of the inductor via the design of the magnetically permeable alloy layer. Therefore, the inductor structure of the present disclosure can meet the required requirements without using a mixture of conventional magnetically permeable elements and conventional magnetic powders.

### BACKGROUND

### 1. Technical Field

The present disclosure relates to an inductor structure, and more particularly, to a coil-shaped inductor structure that can be embedded in a package substrate.

### 2. Description of Related Art

General semiconductor application devices, such as communication or high-frequency semiconductor devices, often need to electrically connect most of the radio-frequency passive elements such as resistors, inductors, capacitors and oscillators to the packaged semiconductor chip, so that the semiconductor chip has a specific current characteristic or emits a signal. For example: There are many types of conventional inductors, with various applications (filtering, choke, DC-DC [direct current to direct current] converter, etc., but not limited to as such) and their advantages and disadvantages.

Taking the spiral inductance element commonly used in devices with radio-frequency modules as an example, under the requirements of high density element configuration and miniaturization of radio-frequency modules, the distance between each element is reduced, and at the same time, it also causes electromagnetic interference between various elements. Therefore, how to avoid electromagnetic interference among various elements, and how to provide better magnetic shielding performance, anti-electromagnetic interference capability and miniaturization of the inductance element itself are the problems faced by the conventional inductance element.

Also, when the spiral inductance element is used at high frequency, how to provide lower magnetic loss and eddy current effect and a higher inductance value to obtain a better Q value (Q stands for quality or quality factor), thereby reducing the energy consumption of the inductance element and improving performance to achieve good electrical properties, is another problem that the conventional inductance element must constantly overcome.

Based on the above problems, the industry such as Taiwan patent application No. TWI611439 (as shown in FIG. 1) uses a magnetic cover 130 to provide magnetic shielding and anti-electromagnetic interference capabilities. However, the magnetic permeability of the magnetic powder mixed in the insulating material is relatively lower than the magnetic permeability of the original magnetic powder, so that the mixture is still limited in improving the inductance value, magnetic shielding and anti-electromagnetic interference capabilities of the inductance element.

Moreover, mixing magnetic powder in the insulating material, the uniformity of the mixture is poor, resulting in difficulty in controlling the magnetic permeability, and after the magnetic powder is formed on the carrier board, it is not suitable for performing the circuit patterning process due to its material characteristics. Therefore, subsequent fabrication of build-up circuits cannot be performed on the dielectric layer or the magnetic cover.

Also, a coil element 100 of Taiwan patent application No. TWI611439 is made by injection molding, transfer molding or low temperature cofiring, resulting in poor processability. Therefore, only small-area processing can be carried out, and large-area mass production is not possible, resulting in an increase in the processing cost of the inductor, and the geometric tolerance of the manufactured coil element is not good, resulting in a poor tolerance of the inductance value.

In addition, the size of a general thin film inductor is about 2.5 mm in length, 2.0 mm in width and 1.8 mm in height, which is extremely difficult for the product to be miniaturized or thinned.

Therefore, how to overcome various problems of the above-mentioned prior art has become a difficult problem urgently to be overcome in the industry.

### SUMMARY

In view of the various deficiencies of the prior art, the present disclosure provides an inductor structure, which comprises: an insulator having a first surface and a second surface opposing the first surface; an inductance circuit being coil-shaped and embedded in the insulator, wherein the inductance circuit further comprises at least one first electrode pad exposed to either the first surface or the second surface of the insulator, and at least one second electrode pad exposed to either the first surface or the second surface of the insulator; and a magnetically permeable alloy layer embedded in the insulator and located in a coil of the inductance circuit without being electrically connected to the inductance circuit, wherein the magnetically permeable alloy layer is a thin board with a cross-section in a continuous rectangular corrugated shape, and an extended length of the magnetically permeable alloy layer is equivalent to an extended length of the coil of the inductance circuit.

In the aforementioned inductor structure, the insulator has a material composition comprising organic photosensitive dielectric material, organic non-photosensitive dielectric material and/or inorganic oxide material.

In the aforementioned inductor structure, the magnetically permeable alloy layer has a material composition comprising iron, nickel, cobalt, zinc or an alloy containing at least two of them, or more than two of them, or an alloy doped with manganese, molybdenum, boron, copper or vanadium.

In the aforementioned inductor structure, the first electrode pad can be used for mounting an active element or a passive element in a flip-chip manner.

In the aforementioned inductor structure, the second electrode pads are electrically connected to and bonded to the circuit board via solder balls.

The present disclosure further provides a method of manufacturing an inductor structure, the method comprises: providing a first carrier board with a metal surface; forming a first circuit layer comprising a plurality of conductors by electroplating on the first carrier board in a photolithography patterned electroplating process, wherein two of the conductors of the first circuit layer are used as a first portion of an inductance circuit, and the other conductors of the first circuit layer are wall-shaped and arranged at intervals to serve as a patterned temporary circuit wall, wherein the patterned temporary circuit wall is not electrically connected to the inductance circuit, and an extended length of the patterned temporary circuit wall is equivalent to an extended length of a coil of the inductance circuit; forming a first conductive column layer by electroplating respectively on the two conductors, which are used as the inductance circuit in the first circuit layer, in a patterning exposure and development manner to be used as a second portion of the inductance circuit, and then forming a first resist layer made of an insulating material to cover the first conductive column layer and the two conductors bonded thereto, and exposing the patterned temporary circuit wall, wherein the first resist layer is made of a photosensitive photoresist material; forming a magnetically permeable alloy layer on a surface of the patterned temporary circuit wall and an exposed surface of the first carrier board, wherein the magnetically permeable alloy layer is a thin board with a cross-section in a continuous corrugated shape, and an extended length of the magnetically permeable alloy layer is equivalent to the extended length of the coil of the inductance circuit; removing the first resist layer, and then forming a first dielectric layer on the first carrier board, wherein the first dielectric layer covers the first conductive column layer, the two conductors as the inductance circuit, the magnetically permeable alloy layer, and the surface of the first carrier board, and part of a material of the first dielectric layer is removed to expose one end surface of the first conductive column layer; forming a second circuit layer by electroplating on the first dielectric layer in a patterning exposure and development manner, wherein the second circuit layer is electrically connected to the exposed end surface of the first conductive column layer, wherein the second circuit layer is used as a third portion of the inductance circuit, and a second dielectric layer is formed on the first dielectric layer to cover the second circuit layer and a surface of the first dielectric layer, and part of a material of the second dielectric layer is removed to expose a surface of the second circuit layer; bonding a second carrier board with a metal material onto the exposed surface of the second circuit layer and the second dielectric layer, and removing the first carrier board to expose the first circuit layer; forming a second conductive column layer by electroplating respectively on exposed surfaces of the two conductors, which are used as the inductance circuit in the first circuit layer, in a patterning exposure and development manner, then forming a second resist layer made of an insulating material to cover the second conductive column layer, wherein the second resist layer is made of a photosensitive photoresist material, wherein the second conductive column layer is used as a fourth portion of the inductance circuit; removing the exposed patterned temporary circuit wall of the first circuit layer by etching to expose a surface of the magnetically permeable alloy layer, and removing the second resist layer; forming a third dielectric layer made of an insulating material on an exposed surface of the first dielectric layer to cover the second conductive column layer, the magnetically permeable alloy layer, and the exposed surface of the first dielectric layer, and removing part of the material of the third dielectric layer to expose one end surface of the second conductive column layer; forming a third circuit layer by electroplating on the third dielectric layer in a patterning exposure and development manner, wherein the third circuit layer is electrically connected to the exposed end surface of the second conductive column layer, wherein the third circuit layer is used as a fifth portion of the inductance circuit; forming at least one conductive column by electroplating on the third circuit layer in an exposure and development manner, and then forming a fourth dielectric layer made of an insulating material on the third dielectric layer to cover the third circuit layer and the conductive column, and removing part of the material of the fourth dielectric layer to expose one end surface of the conductive column for serving as a first electrode pad of the inductance circuit to an outside; and removing the second carrier board to expose the surface of the second circuit layer; wherein the second circuit layer, the first conductive column layer, the two conductors of the first circuit layer, the second conductive column layer and the third circuit layer are bonded to form the inductance circuit being coil-shaped, and the magnetically permeable alloy layer is located in the coil of the inductance circuit.

In the aforementioned method, the patterned temporary circuit wall has a cross-section in rectangular shape, convex arc shape or trapezoidal shape, so that the magnetically permeable alloy layer has the cross-section corresponding to be the thin board in a continuous rectangular corrugated shape, a convex arc corrugated shape or a trapezoidal corrugated shape.

In the aforementioned method, the first resist layer and the second resist layer are made of photosensitive photoresist materials.

In the aforementioned method, the first dielectric layer, the second dielectric layer, the third dielectric layer and the fourth dielectric layer have a material composition comprising organic photosensitive dielectric material, organic non-photosensitive dielectric material and/or inorganic oxide material.

In the aforementioned method, the magnetically permeable alloy layer has a material composition comprising iron, nickel, cobalt, zinc or an alloy containing at least two of them, or more than two of them, or an alloy doped with manganese, molybdenum, boron, copper or vanadium.

In the aforementioned method, the method further comprises forming a plurality of second electrode pads on the exposed surface of the second circuit layer.

As can be seen from the above, in the inductor structure of the present disclosure and the manufacturing method thereof, the design of the magnetically permeable alloy layer is mainly used to improve the electrical characteristics of the inductor. Therefore, compared with the prior art, the inductor structure of the present disclosure can meet the required requirements without using the mixture of the conventional magnetically permeable element and the conventional magnetic powder, thereby overcoming various deficiencies of the prior art.

### BRIEF DESCRIPTION OF THE DRAWINGS

FIG. 1 is a schematic cross-sectional view of a conventional inductor structure.

FIG. 2A-1, FIG. 2B, FIG. 2C, FIG. 2D, FIG. 2E, FIG. 2F, FIG. 2G and FIG. 2H are schematic cross-sectional views illustrating a manufacturing method of an inductor structure according to the present disclosure.

FIG. 2A-2 is a schematic partial three-dimensional top view of FIG. 2A-1.

FIG. 3 is a schematic partial cross-sectional view of FIG. 2H.

FIG. 4 is a schematic cross-sectional view showing a subsequent process of FIG. 2H.

FIG. 5A to FIG. 5D are schematic partial three-dimensional views showing different aspects of a magnetically permeable alloy layer of the inductor structure according to the present disclosure.

### DETAILED DESCRIPTIONS

The following describes the implementation of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “on,” “first,” “second,” “a,” “one” and the like used herein are merely used for clear explanation rather than limiting the practicable scope of the present disclosure, and thus, alterations or adjustments of the relative relationships thereof without essentially altering the technical contents should still be considered in the practicable scope of the present disclosure.

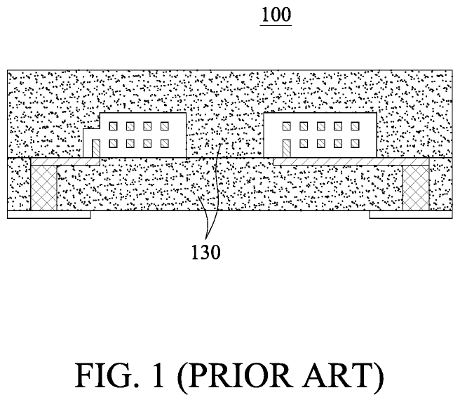

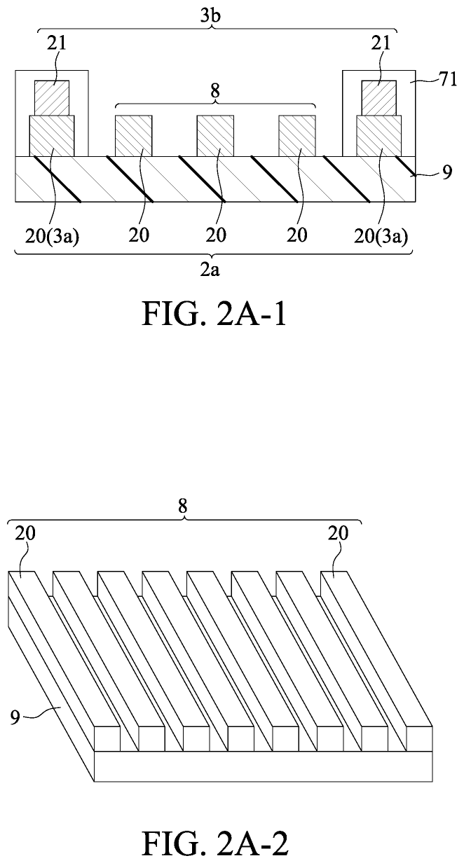

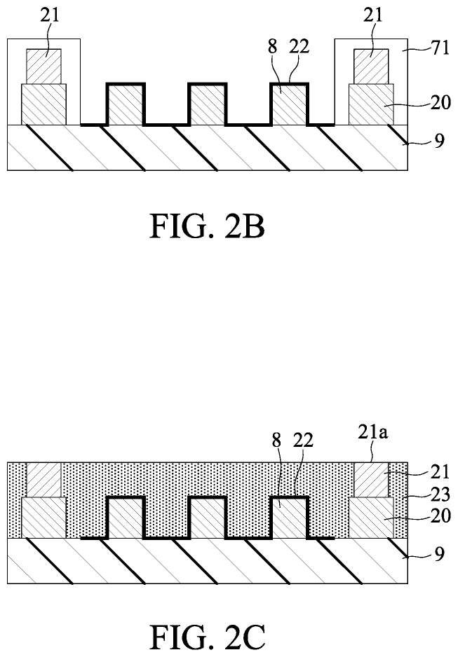

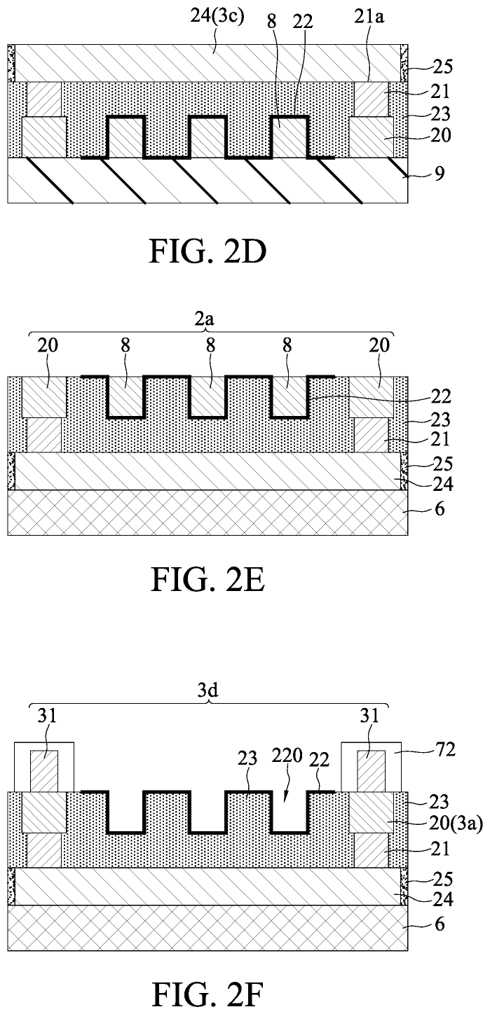

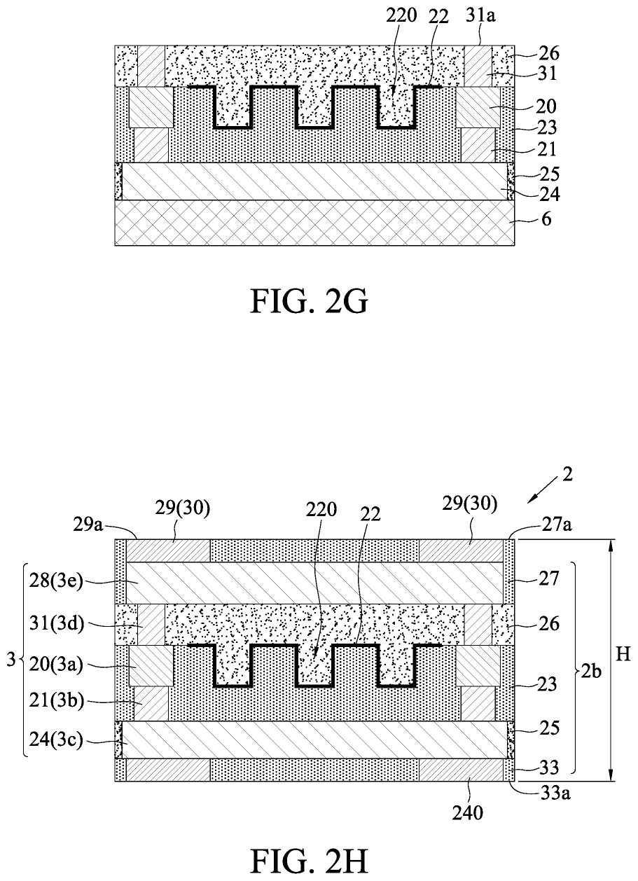

FIG. 2A-1, FIG. 2B, FIG. 2C, FIG. 2D, FIG. 2E, FIG. 2F, FIG. 2G and FIG. 2H are schematic cross-sectional views illustrating a manufacturing method of an inductor structure 2 according to the present disclosure.

As shown in FIG. 2A-1, a first carrier board 9 with a metal surface is provided, and then a first circuit layer 2a comprising a plurality of conductors 20 is formed by electroplating on the first carrier board 9 in a patterning exposure and development manner, wherein two of the conductors 20 of the first circuit layer 2a are used as a first portion 3a of an inductance circuit 3, and the other conductors 20 of the first circuit layer 2a are arranged at intervals to serve as a patterned temporary circuit wall 8, as shown in FIG. 2A-2, wherein the patterned temporary circuit wall 8 is not electrically connected to the inductance circuit 3, and the extended length of the patterned temporary circuit wall 8 is equivalent to the extended length of the coil of the inductance circuit 3, and the cross-section of the patterned temporary circuit wall 8 can be patterned into a rectangle, a convex arc, a trapezoid or other geometric shapes according to requirements. Next, a first conductive column layer 21 is formed by electroplating respectively on the two conductors 20, which are used as the inductance circuit 3 in the first circuit layer 2a, in a patterning exposure and development manner to be used as a second portion 3b of the inductance circuit 3, and then a first resist layer 71 formed with an insulating material covers the first conductive column layer 21 and the two conductors 20 bonded thereto, and the patterned temporary circuit wall 8 is exposed.

In one embodiment, the first carrier board 9 is a copper foil substrate, and the first resist layer 71 is made of a photosensitive photoresist material, but the present disclosure is not limited to as such.

Furthermore, the patterning process is applied with a redistribution layer (RDL) process to manufacture the first circuit layer 2a. For example, the conductors 20 are copper bumps.

As shown in FIG. 2B, a magnetically permeable alloy layer 22 is formed on the surface of the patterned temporary circuit wall 8 and the exposed surface of the first carrier board 9 (e.g., the magnetically permeable alloy layer 22 is formed by electroplating or deposition), and the cross-sectional shape of the magnetically permeable alloy layer 22 is correspondingly similar to the cross-sectional shape of the patterned temporary circuit wall 8, and can be a thin board with rectangular corrugated shape, convex arc corrugated shape, trapezoidal corrugated shape or other geometric corrugated shapes.

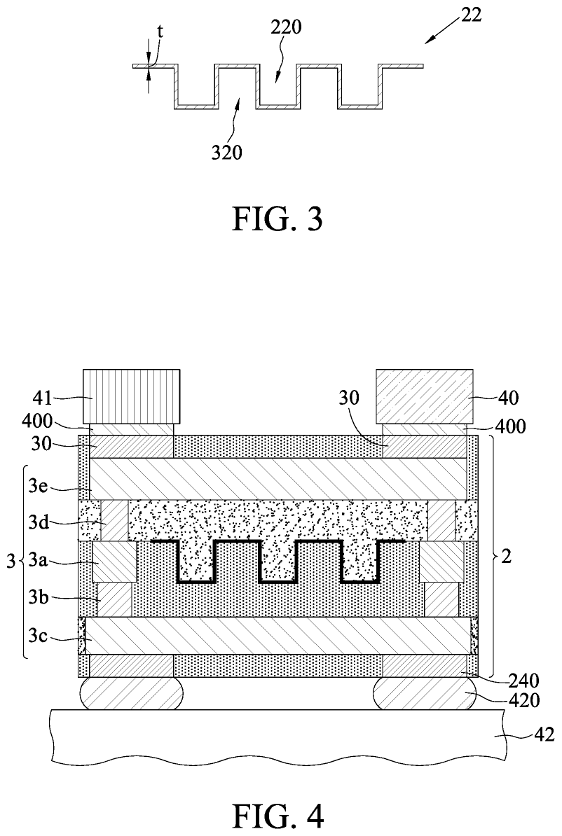

In one embodiment, the magnetically permeable alloy layer 22 is an alloy metal with high magnetic permeability, and its material composition includes iron, nickel, cobalt, zinc or at least two of them, or alloys containing more than two of them, or alloys doped with materials such as manganese, molybdenum, boron, copper, or vanadium. For example, a thickness t of the magnetically permeable alloy layer 22 is less than 10 micrometers (μm), as shown in FIG. 3.

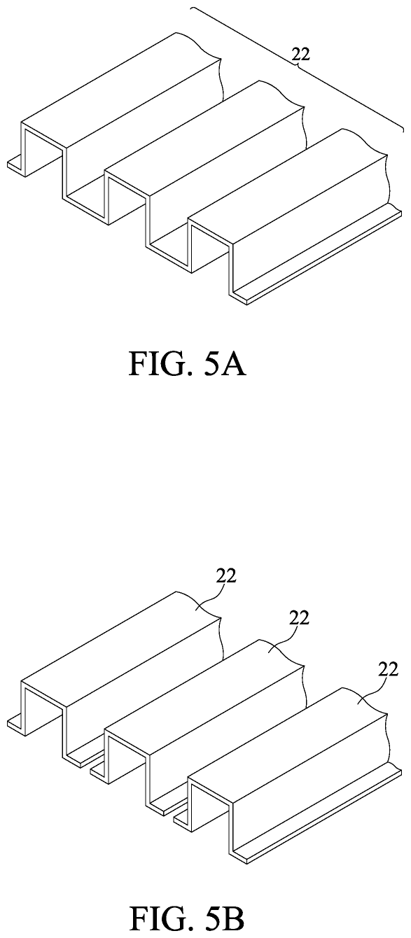

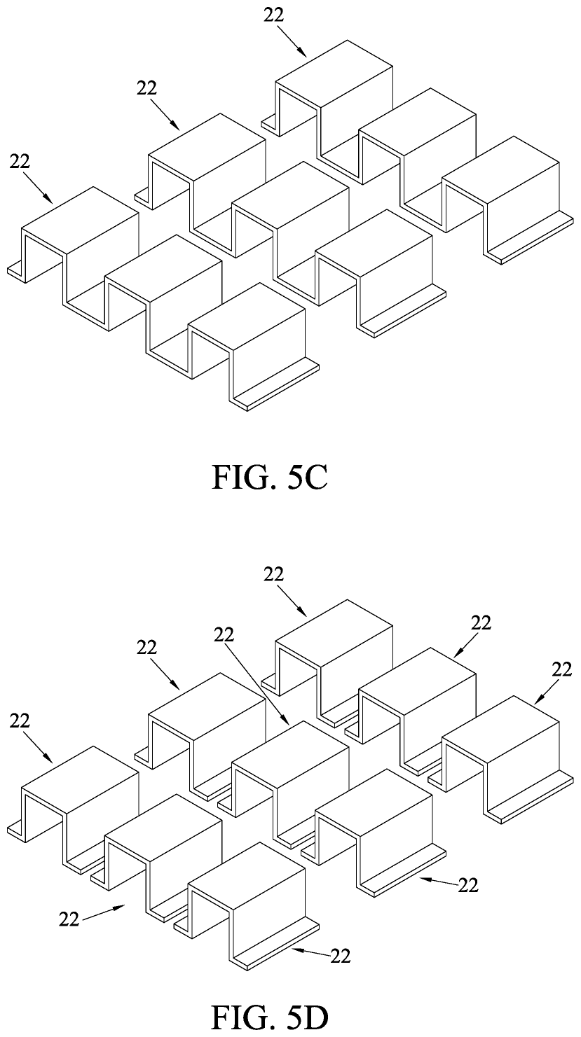

Moreover, the structural design of the magnetically permeable alloy layer 22 can be a thin board in a continuous or discontinuous rectangular corrugated shape according to requirements, such as a thin board with a continuous rectangular corrugation in complete shape shown in FIG. 5A, a thin board with a non-continuous rectangular corrugation that is longitudinally cut (or multiple groups of rectangular strips separated from each other) shown in FIG. 5B, a thin board with a non-continuous rectangular corrugation that is transversely cut (or multiple groups of concave-convex sheets separated from each other) shown in FIG. 5C, and a thin board with a non-continuous rectangular corrugation that is longitudinally and transversely cut (or multiple groups of rectangular sheets separated from each other) shown in FIG. 5D.

As shown in FIG. 2C, the first resist layer 71 is removed by etching, and then a first dielectric layer 23 is formed on the first carrier board 9, so that the first dielectric layer 23 covers the first conductive column layer 21, the two conductors 20 as the first portion 3a of the inductance circuit 3, the magnetically permeable alloy layer 22, and the surface of the first carrier board 9. Then, a leveling operation is performed to remove part of the material of the first dielectric layer 23 by grinding to expose an end surface 21a of the first conductive column layer 21, so that the end surface 21a of the first conductive column layer 21 is flush with the surface of the first dielectric layer 23.

In one embodiment, the first dielectric layer 23 is formed on the first carrier board 9 by molding, coating or pressing (lamination).

As shown in FIG. 2D, a second circuit layer 24 is formed by electroplating on the first dielectric layer 23 in a patterning exposure and development manner, so that the second circuit layer 24 is electrically connected to the exposed end surface 21a of the first conductive column layer 21, wherein the second circuit layer 24 is used as a third portion 3c of the inductance circuit 3, and a second dielectric layer 25 is formed on the first dielectric layer 23 to cover the second circuit layer 24 and the surface of the first dielectric layer 23. Then, a leveling operation is performed to remove part of the material of the second dielectric layer 25 by grinding, so that the surface of the second circuit layer 24 is flush with the surface of the second dielectric layer 25, so as to expose the surface of the second circuit layer 24.

In one embodiment, the second circuit layer 24 is a metal layer made of such as copper, and the second dielectric layer 25 is formed on the first dielectric layer 23 by molding, coating or pressing (lamination).

As shown in FIG. 2E, a second carrier board 6 with a metal material on the surface thereof is bonded onto the exposed surfaces of the second dielectric layer 25 and the second circuit layer 24, and then the whole structure is turned over. Then, the first carrier board 9 is removed to expose the first circuit layer 2a and the magnetically permeable alloy layer 22.

As shown in FIG. 2F, a second conductive column layer 31 is respectively formed on the exposed surfaces of the two conductors 20, which are used as the first portion 3a of the inductance circuit 3 in the first circuit layer 2a, in a patterning exposure and development manner, then a second resist layer 72 made of an insulating material is formed to cover the second conductive column layer 31, wherein the second resist layer 72 covers the two conductors 20, the plurality of second conductive column layers 31 and the surface of the first dielectric layer 23 around them, but does not cover the magnetically permeable alloy layer 22 and the patterned temporary circuit wall 8, so that the magnetically permeable alloy layer 22, the patterned temporary circuit wall 8 and the remaining surfaces of the first dielectric layer 23 are exposed from the second resist layer 72. Then, the patterned temporary circuit wall 8 of the first circuit layer 2a is removed by etching to expose the surface of the magnetically permeable alloy layer 22, and a plurality of concave portions 220 formed by the magnetically permeable alloy layer 22 are formed on the surface of the first dielectric layer 23.

In one embodiment, the second conductive column layer 31 is used as a fourth portion 3d of the inductance circuit 3, and the second resist layer 72 is made of a photosensitive photoresist material.

Furthermore, the magnetically permeable alloy layer 22 is a concave-convex sheet-like three-dimensional structure, and the concave portion 220 thereof is a hollow column structure. It should be understood that the concavity and convexity of the magnetically permeable alloy layer 22 are relative positions, so the concave portion 220 is a convex portion when viewed from the other side.

As shown in FIG. 2G, the second resist layer 72 is removed to expose the end surface of the conductor 20 and the second conductive column layer 31. Afterward, a third dielectric layer 26 made of an insulating material is formed on the exposed surface of the first dielectric layer 23 and in the concave portion 220 to cover the second conductive column layer 31, the magnetically permeable alloy layer 22, and the exposed surface of the first dielectric layer 23. Then, a leveling operation is performed to remove part of the material of the third dielectric layer 26 by grinding, so that the end surface of the second conductive column layer 31 is flush with the surface of the third dielectric layer 26, wherein an end surface 31a of the second conductive column layer 31 is exposed from the third dielectric layer 26.

In one embodiment, the third dielectric layer 26 is formed on the first dielectric layer 23 and in the concave portion 220 by molding, coating or pressing (lamination).

Moreover, the hollow portions of the magnetically permeable alloy layer 22 (as shown in FIG. 3, the concave portion 220 on one side and a concave portion 320 on the other side) is covered by a dielectric material (i.e., the first dielectric layer 23 and the third dielectric layer 26).

As shown in FIG. 2H, a third circuit layer 28 is formed by electroplating on the third dielectric layer 26 in a patterning exposure and development manner, so that the third circuit layer 28 is electrically connected to the exposed end surface 31a of the second conductive column layer 31, wherein the third circuit layer 28 is used as a fifth portion 3e of the inductance circuit 3. Next, at least one conductive column 29 is formed by electroplating on the third circuit layer 28 in an exposure and development manner, and then a fourth dielectric layer 27 made of an insulating material is formed on the third dielectric layer 26 to cover the third circuit layer 28 and the conductive column 29. Afterward, a leveling operation is performed to remove part of the material of the fourth dielectric layer 27 by grinding, so that an end surface 29a of the conductive column 29 is flush with the surface of the fourth dielectric layer 27, wherein the end surface 29a of the conductive column 29 is exposed from the fourth dielectric layer 27 for serving as a first electrode pad 30 of the inductance circuit 3 to the outside. Finally, the second carrier board 6 is removed to expose the surface of the second circuit layer 24.

In one embodiment, the second circuit layer 24, the first conductive column layer 21, the two conductors 20 of the first circuit layer 2a, the second conductive column layer 31 and the third circuit layer 28 are combined to form the inductance circuit 3 in a coil shape (e.g., the inductance circuit 3 is a helical coil inductance circuit, a solenoid coil inductance circuit or a toroidal coil inductance circuit), and the magnetically permeable alloy layer 22 is located in the coil of the inductance circuit 3, wherein the first dielectric layer 23, the second dielectric layer 25, the third dielectric layer 26, the fourth dielectric layer 27 and a fifth dielectric layer 33 are used as an insulator 2b.

Furthermore, the fourth dielectric layer 27 is formed on the third dielectric layer 26 by molding, coating or pressing (lamination). It should be understood that the materials of at least two of the first dielectric layer 23, the second dielectric layer 25, the third dielectric layer 26 and the fourth dielectric layer 27 may be the same or different.

Also, before performing the process step of bonding the second carrier board 6, a plurality of second electrode pads 240 may be formed on the second dielectric layer 25, and the second electrode pads 240 are electrically connected to the second circuit layer 24; then the fifth dielectric layer 33 is formed to cover the second electrode pads 240 and the surface of the second dielectric layer 25, and a leveling operation is further performed to remove part of the fifth dielectric layer 33, so that one of end surfaces of each of the second electrode pads 240 is exposed; wherein one of end surfaces of each of the second electrode pads 240 is exposed after performing the process step of removing the second carrier board 6.

In addition, the constituent materials of the first dielectric layer 23, the second dielectric layer 25, the third dielectric layer 26, the fourth dielectric layer 27 and the fifth dielectric layer 33 include organic photosensitive dielectric materials or organic non-photosensitive dielectric materials, which for example include insulating materials containing glass fibers and organic resins. Among them, organic resins include but are not limited to epoxy resins such as base material or prepreg of bismaleimide triazine (BT), FR4 or FR5 (FR stands for flame resistant/retardant), organic base material ABF (Ajinomoto Build-up Film), epoxy molding resin (epoxy molding compound [EMC]), film EMC or polyimide (PI). The material of part of the dielectric layer may also include micron or nanoscale inorganic oxide materials, such as silicon oxide, nickel oxide or copper oxide. In some embodiments, the dielectric layers can be composed of the same or different materials.

Therefore, the manufacturing method of the present disclosure utilizes a carrier board manufacturing method to make the micro-inductor structure 2 or an inductance element embedded in an integrated circuit (IC) carrier board, and utilizes a metal alloy with a high magnetic permeability as the magnetically permeable alloy layer 22 cooperating with the manufacturing method of the carrier board to complete the inductor structure 2 with a thickness H. Accordingly, using the circuit design and the characteristics of the dielectric material, the circuit is designed to form the inductance circuit 3 that is an induction coil, and the center of the coil is electroplated with the high-permeability magnetically permeable alloy layer 22, so that the electrical characteristics of the inductor structure 2 can be improved, so as to meet the needs of large inductance value or thinning. Hence, the production process and cost can be reduced, and the inductor structure 2 can be made with extremely small size so as to meet the needs of miniaturization or thinning of products.

In addition, the inductance coil (the inductance circuit 3) can be designed to be embedded in the package substrate, so that the package substrate has the function of embedding inductance elements, so there is no need to add other inductance elements during the packaging process. For example, an active element 40 such as a semiconductor chip or a passive element 41 such as a capacitor or a resistor can be bonded onto the first electrode pad 30 of the package substrate via a soldering material 400 in a flip-chip manner, as shown in FIG. 4, so that the active element 40 or the passive element 41 is electrically connected to the inductance circuit 3. Alternatively, the second electrode pads 240 of the package substrate can be electrically connected to and bonded to a circuit board 42 via solder balls 420.

The present disclosure also provides an inductor structure 2, which comprises: an insulator 2b, a coiled inductance circuit 3 embedded in the insulator 2b, and at least one magnetically permeable alloy layer 22.

The insulator 2b has a first surface 27a and a second surface 33a opposing the first surface 27a.

The inductance circuit 3 includes at least one first electrode pad 30 exposed from the first surface 27a of the insulator 2b, and at least one second electrode pad 240 exposed from the second surface 33a of the insulator 2b.

The magnetically permeable alloy layer 22 is embedded in the insulator 2b, and is located in the coil of the inductance circuit 3 but not electrically connected to the inductance circuit 3, wherein the magnetically permeable alloy layer 22 is a thin board with a cross-section in a continuous rectangular corrugated shape, and the magnetically permeable alloy layer 22 can also be a thin board with a cross-section in a convex arc corrugated shape, trapezoidal corrugated shape or other geometric corrugated shapes according to design requirements.

In one embodiment, the material composition of the insulator 2b includes an organic photosensitive dielectric material or an organic non-photosensitive dielectric material, which for example includes an insulating material containing glass fiber and organic resin. Among them, organic resin includes but is not limited to epoxy resin such as base material or prepreg of bismaleimide triazine (BT), FR4 or FR5 (FR stands for flame resistant/retardant), organic base material ABF (Ajinomoto Build-up Film), epoxy molding resin (epoxy molding compound [EMC]), film EMC or polyimide (PI). The material of part of the dielectric layer may also include micron or nanoscale inorganic oxide materials, such as silicon oxide, nickel oxide or copper oxide. In some embodiments, the dielectric layers can be composed of the same or different materials.

In one embodiment, the material composition of the magnetically permeable alloy layer 22 includes iron, nickel, cobalt, zinc, or an alloy containing at least two of them, or more than two of them, or an alloy doped with a material such as manganese, molybdenum, boron, copper or vanadium and the like.

In one embodiment, the first electrode pad 30 is bonded to an active element 40 or a passive element 41 in a flip-chip manner.

In one embodiment, the second electrode pads 240 are electrically connected to and bonded to a circuit board 42 via solder balls 420.

In summary, the inductor structure 2 of the present disclosure and the manufacturing method thereof are configured with the magnetically permeable alloy layer 22, thus having the following advantages:

First, the magnetically permeable alloy layer 22 is designed with a 3D (three-dimensional) concave-convex structure, which can increase the surface area, and only need a single-layer design to achieve multi-layer effects, thereby effectively reducing material costs.

Second, the thickness t of the magnetically permeable alloy layer 22 can be effectively reduced according to requirements, so as to increase the magnetic permeability.

Third, the magnetically permeable alloy layer 22 does not require copper as a seed layer in the manufacturing process, thereby eliminating the problem of affecting the magnetic permeability due to the low resistance of copper.

Fourth, the surface roughness design of the magnetically permeable alloy layer 22 can avoid the problem that the dielectric material needs to be roughened due to the process requirements of the circuit semi-additive method, which will cause the metal surface to change accordingly, and then affect the magnetic permeability.

In addition, compared with the configuration of the iron core block of the prior art, the inductor structure 2 of the present disclosure does not need to configure the iron core block. Therefore, the inductor structure of the present disclosure is easier to be miniaturized, so that the end product can meet the requirement of miniaturization.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. An inductor structure, comprising:
an insulator having a first surface and a second surface opposing the first surface;
an inductance circuit being coil-shaped and embedded in the insulator, wherein the inductance circuit further comprises at least one first electrode pad exposed to either the first surface or the second surface of the insulator, and at least one second electrode pad exposed to either the first surface or the second surface of the insulator; and
a magnetically permeable alloy layer embedded in the insulator and located in a coil of the inductance circuit without being electrically connected to the inductance circuit, wherein the magnetically permeable alloy layer is a thin board with a cross-section in a continuous corrugated shape, and an extended length of the magnetically permeable alloy layer is equivalent to an extended length of the coil of the inductance circuit.

2. The inductor structure of claim 1, wherein the magnetically permeable alloy layer is a thin board with a cross-section in a continuous rectangular corrugated shape, a convex arc corrugated shape or a trapezoidal corrugated shape.

3. The inductor structure of claim 1, wherein the magnetically permeable alloy layer is a structure that is longitudinally divided to a plurality of strip-shaped boards that are arranged at intervals in columns, a structure that is transversely divided to a plurality of strip-shaped corrugated boards that are arranged at intervals in rows, or a structure that is grid divided to a plurality of convex-shaped boards that are arranged at intervals in a matrix.

4. The inductor structure of claim 1, wherein the insulator has a material composition comprising organic photosensitive dielectric material, organic non-photosensitive dielectric material and/or inorganic oxide material.

5. The inductor structure of claim 1, wherein the insulator has a material composition comprising an organic resin, and the organic resin includes but not limited to epoxy resins such as base material or prepreg of bismaleimide triazine, flame resistant 4 or flame resistant 5, organic base material Ajinomoto Build-up Film, epoxy molding compound, film epoxy molding compound or polyimide.

6. The inductor structure of claim 1, wherein the insulator has a material composition comprising an inorganic oxide material, and the inorganic oxide material includes but not limited to silicon oxide, nickel oxide or copper oxide.

7. The inductor structure of claim 6, wherein the inorganic oxide material includes micron or nanoscale inorganic oxide material.

8. The inductor structure of claim 1, wherein the magnetically permeable alloy layer has a material composition comprising iron, nickel, cobalt, zinc or an alloy containing at least two of them, or more than two of them, or an alloy doped with manganese, molybdenum, boron, copper or vanadium.

9. The inductor structure of claim 1, wherein the inductance circuit is a helical coil inductance circuit, a solenoid coil inductance circuit or a toroidal coil inductance circuit.

10. The inductor structure of claim 1, wherein the first electrode pad and/or the second electrode pad are packaged and bonded to at least one active element and/or one passive element, and bonded to at least one external conductive element.

11. A method of manufacturing an inductor structure, comprising:
providing a first carrier board with a metal surface;
forming a first circuit layer comprising a plurality of conductors by electroplating on the first carrier board in a photolithography patterned electroplating process, wherein two of the conductors of the first circuit layer are used as a first portion of an inductance circuit, and the other conductors of the first circuit layer are wall-shaped and arranged at intervals to serve as a patterned temporary circuit wall, wherein the patterned temporary circuit wall is not electrically connected to the inductance circuit, and an extended length of the patterned temporary circuit wall is equivalent to an extended length of a coil of the inductance circuit;
forming a first conductive column layer by electroplating respectively on the two conductors, which are used as the inductance circuit in the first circuit layer, in a patterning exposure and development manner to be used as a second portion of the inductance circuit, and then forming a first resist layer made of an insulating material to cover the first conductive column layer and the two conductors bonded thereto, and exposing the patterned temporary circuit wall, wherein the first resist layer is made of a photosensitive photoresist material;
forming a magnetically permeable alloy layer on a surface of the patterned temporary circuit wall and an exposed surface of the first carrier board, wherein the magnetically permeable alloy layer is a thin board with a cross-section in a continuous corrugated shape, and an extended length of the magnetically permeable alloy layer is equivalent to the extended length of the coil of the inductance circuit;
removing the first resist layer, and then forming a first dielectric layer on the first carrier board, wherein the first dielectric layer covers the first conductive column layer, the two conductors as the inductance circuit, the magnetically permeable alloy layer, and the surface of the first carrier board, and part of a material of the first dielectric layer is removed to expose one end surface of the first conductive column layer;
forming a second circuit layer by electroplating on the first dielectric layer in a patterning exposure and development manner, wherein the second circuit layer is electrically connected to the exposed end surface of the first conductive column layer, wherein the second circuit layer is used as a third portion of the inductance circuit, and a second dielectric layer is formed on the first dielectric layer to cover the second circuit layer and a surface of the first dielectric layer, and part of a material of the second dielectric layer is removed to expose a surface of the second circuit layer;
bonding a second carrier board with a metal material onto the exposed surface of the second circuit layer and the second dielectric layer, and removing the first carrier board to expose the first circuit layer;
forming a second conductive column layer by electroplating respectively on exposed surfaces of the two conductors, which are used as the inductance circuit in the first circuit layer, in a patterning exposure and development manner, then forming a second resist layer made of an insulating material to cover the second conductive column layer, wherein the second resist layer is made of a photosensitive photoresist material, wherein the second conductive column layer is used as a fourth portion of the inductance circuit;
removing the exposed patterned temporary circuit wall of the first circuit layer by etching to expose a surface of the magnetically permeable alloy layer, and removing the second resist layer;
forming a third dielectric layer made of an insulating material on an exposed surface of the first dielectric layer to cover the second conductive column layer, the magnetically permeable alloy layer, and the exposed surface of the first dielectric layer, and removing part of the material of the third dielectric layer to expose one end surface of the second conductive column layer;
forming a third circuit layer by electroplating on the third dielectric layer in a patterning exposure and development manner, wherein the third circuit layer is electrically connected to the exposed end surface of the second conductive column layer, wherein the third circuit layer is used as a fifth portion of the inductance circuit;
forming at least one conductive column by electroplating on the third circuit layer in an exposure and development manner, and then forming a fourth dielectric layer made of an insulating material on the third dielectric layer to cover the third circuit layer and the conductive column, and removing part of the material of the fourth dielectric layer to expose one end surface of the conductive column for serving as a first electrode pad of the inductance circuit to an outside; and
removing the second carrier board to expose the surface of the second circuit layer;
wherein the second circuit layer, the first conductive column layer, the two conductors of the first circuit layer, the second conductive column layer and the third circuit layer are bonded to form the inductance circuit being coil-shaped, and the magnetically permeable alloy layer is located in the coil of the inductance circuit.

12. The method of claim 11, wherein the patterned temporary circuit wall has a cross-section in rectangular shape, convex arc shape or trapezoidal shape, so that the magnetically permeable alloy layer has the cross-section corresponding to be the thin board in a continuous rectangular corrugated shape, a convex arc corrugated shape or a trapezoidal corrugated shape.

13. The method of claim 11, wherein the magnetically permeable alloy layer is formed by electroplating or deposition.

14. The method of claim 11, wherein the inductance circuit is a helical coil inductance circuit, a solenoid coil inductance circuit or a toroidal coil inductance circuit.

15. The method of claim 11, further comprising:
forming a plurality of second electrode pads on the second dielectric layer before performing a process step of bonding the second carrier board, wherein the second electrode pads are electrically connected to the second circuit layer;
forming a fifth dielectric layer to cover the second electrode pads and a surface of the second dielectric layer, and performing a leveling operation to remove part of the fifth dielectric layer, such that one end surface of each of the second electrode pads is exposed; and
exposing the one end surface of each of the second electrode pads after performing a process step of removing the second carrier board.
